(19) United States
(12) Patent Application Publication
(10) Pub. No.: US 2015/0210233 A1
(43) Pub. Date: Jul. 30, 2015

(54) AUTOMATED VIEWING ANGLE ADJUSTMENT OF VIEWABLE COMPONENTS

(71) Applicant: Lenovo (Singapore) Pte. Ltd., Singapore (SG)

(72) Inventors: Arnold S. Weksler, Raleigh, NC (US); Rod D. Waltermann, Rougemont, NC (US); Nathan J. Peterson, Durham, NC (US); John Carl Mese, Cary, NC (US); Russell Speight VanBlon, Raleigh, NC (US)

(73) Assignee: Lenovo (Singapore) Pte. Ltd., Singapore (SG)

(21) Appl. No.: 14/164,576

(22) Filed: Jan. 27, 2014

(51) Int. Cl. B60R 16/037; G06T 7/00; G06F 3/01

(52) U.S. Cl. CPC B60R 16/037; G06F 3/012; G06T 7/004; G06T 2207/30196; G06T 2207/30268

(57) ABSTRACT

An embodiment provides a method, including: detecting, from a received sensor input, a current viewing position of a user with respect to a viewable component; determining, using a processor, a current viewing angle of the user with respect to the viewable component; and adjusting, via actuating movement of the viewable component, orientation of the viewable component based on the current viewing angle determined. Other aspects are described and claimed.

### BACKGROUND

Many devices provide viewable information to users, e.g., display screens such as televisions, mirrors such as in-care mirrors, and the like. In various contexts the viewing angle is important and needs to be adjusted for more appropriate or convenient viewing. For example, the viewing angle of a rearview and side view mirrors of a car are often adjusted to suit a particular driver, e.g., depending on the driver's characteristics such as height, etc. Likewise, when viewing content on a display device, e.g., LCD panel in a vehicle (or elsewhere, particularly where ambient light might cause glare), users may shift the viewing angle (either via shifting themselves and/or shifting the display's orientation) to gain a better view, avoid glare, etc.

Many attempts have been made at appropriately adjusting the view afforded by such viewable components. For example, some display devices may adjust certain display settings depending on ambient light, the time of day, etc. Likewise, some automobiles include controls for adjusting the positioning of rear and/or side view mirrors, with custom settings being storable.

### BRIEF SUMMARY

In summary, one aspect provides a method, comprising: detecting, from a received sensor input, a current viewing position of a user with respect to a viewable component; determining, using a processor, a current viewing angle of the user with respect to the viewable component; and adjusting, via actuating movement of the viewable component, orientation of the viewable component based on the current viewing angle determined.

Another aspect provides an information handling device, comprising: a sensor; a processor operatively coupled to the sensor; and a memory device storing instructions executable by the processor to: detect, using the sensor, a current viewing position of a user with respect to a viewable component; determine a current viewing angle of the user with respect to the viewable component; and adjust, via actuating movement of the viewable component, orientation of the viewable component based on the current viewing angle determined.

A further aspect provides a vehicle, comprising: a motor; one or more wheels operatively coupled to the motor; a chassis compartment for a user; a sensor that provides input relating to the chassis compartment; a processor operatively coupled to the sensor; and a memory device storing instructions executable by the processor to: detect, using the sensor, a current viewing position of a user with respect to a viewable component; determine a current viewing angle of the user with respect to the viewable component; and adjust, via actuating movement of the viewable component, orientation of the viewable component based on the current viewing angle determined.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of automated viewing angle adjustment of viewable components.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Adjusting viewable components such as automobile external mirrors or newer in car displays (e.g., LCD screens) is conventionally done manually by each user. In addition to being cumbersome, the adjustments may not be correct. Many cars have a user selectable memory for adjusting the external mirrors (along with other settings e.g., seat position), although these are static settings in that the settings do not have the capability of adjusting dynamically based on user movement or repositioning. Additionally, these settings exclude certain viewable components, e.g., an in-car LCD display. Thus, for such viewable components, a user needs to resort to manual adjustment, e.g., to maximize LCD screen tilt.

Another problem with the memory or stored position settings is that they still require the user to manually set the positions of all components (e.g., seat, mirror, etc.) and then save the settings. Even with the saved settings, if the user does not sit the same way, e.g., slouches in the seat, the user will need to update the settings accordingly. In addition, the user might not set the viewing angles of the viewable components, e.g., external mirrors, to the optimal location. For example, it is common that some drivers remain unaware as to the proper viewing angles at which to set the car's mirrors in order to avoid collisions.

Accordingly, an embodiment provides an automated way to adjust the viewing angle of viewable components such as external mirrors, LCD panels, etc. An embodiment detects, using a sensor, a current viewing position of a user with respect to a viewable component. Given this information, an embodiment may determine a current viewing angle of the user with respect to the viewable component, i.e., based on the detect position of the user, e.g., a driver of an automobile. An embodiment may therefore automatically adjust, e.g., physically moving the viewable component, such that the orientation of the viewable component is properly adjusted to a correct viewing angle based on the current position of the user/driver. For example, an embodiment may match the adjusted viewing angle, considering the positioning of the user, to a predetermined viewing angle that is known to be appropriate for the viewing component, e.g., adjusting the side view or rearview mirror of a car.

The illustrated example embodiments will be best understood by reference to the figures. The following description is intended only by way of example, and simply illustrates certain example embodiments.

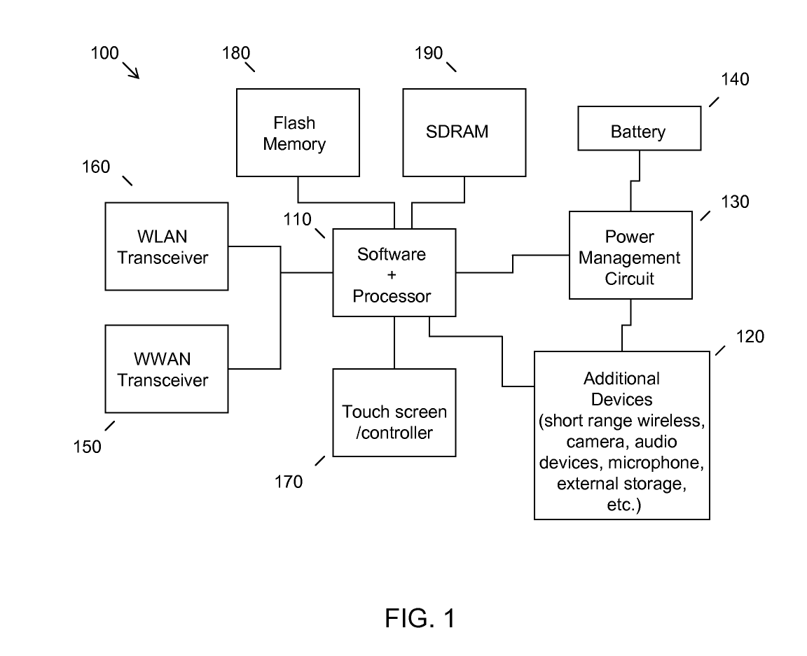

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a camera. Commonly, system 100 will include a touch screen 170 for data input and display. System 100 also typically includes various memory devices, for example flash memory 180 and SDRAM 190.

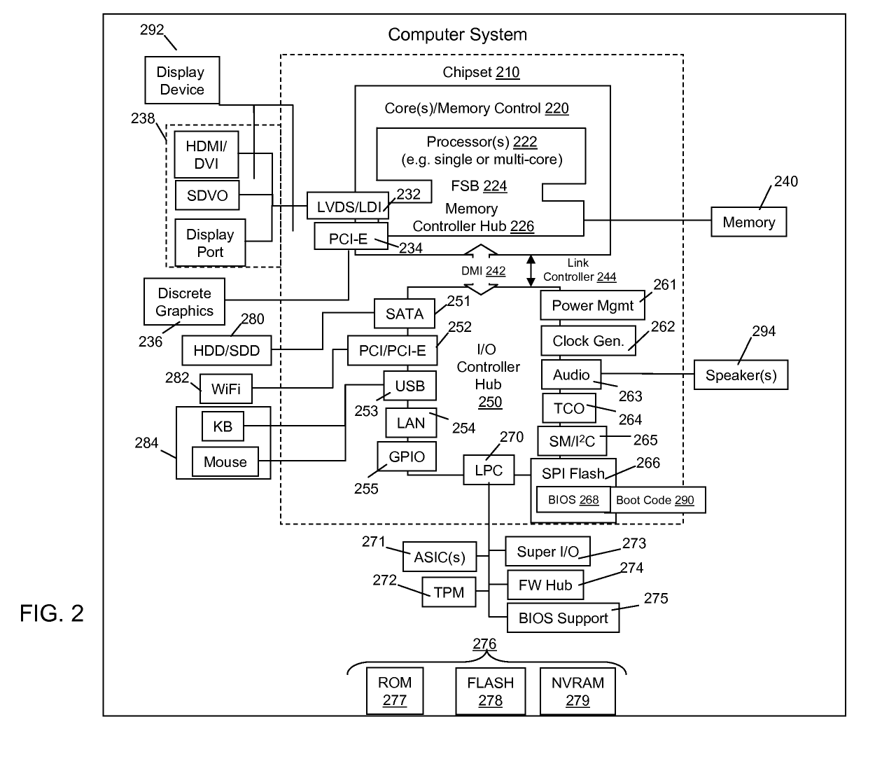

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280, etc.), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may used in devices that provide for automated viewing angle adjustment of viewable components. For example, circuitry as outlined in the examples of FIG. 1 and FIG. 2 may be used to operate a sensor, e.g., a camera positioned in the center of an in-car console having an LCD display, that detects a user's position, e.g., with respect to a viewable component such as the LCD display and/or in car mirrors. An embodiment may then determine a position of the user and thereafter automatically adjust the orientation of viewable component(s) on the basis thereof.

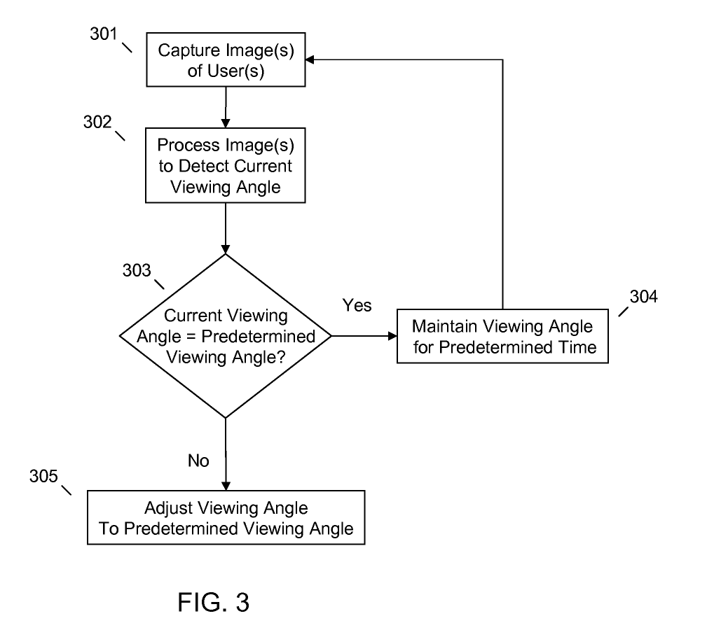

Referring to FIG. 3, for example, once the user is ready, for example a driver is seated in the driver's seat, an embodiment may capture images of the user at 301, e.g., operate one or more cameras to capture images of the user. An embodiment may process the images at 302 to locate the driver's eyes (or other usable metric for calculating a current viewing angle, e.g., head position) detect the current viewing angle with respect to one or more viewable components. Given this information, an embodiment may determine at 304 if a current viewing angle with respect to a viewing component is equal to (or within a predetermined amount of) a predetermined viewing angle, e.g., known to be appropriate for certain situations. If the driver happens to be positioned appropriately in terms of viewing angle(s), the viewable component(s) may not be adjusted at 304. However, if an embodiment determines that a current viewing angle is not appropriate, an embodiment may adjust the viewable component such that the current viewing angle is changed to match a predetermined viewing angle at 305.

For example, an embodiment may determine viewing angles with respect to all of the mirrors of a car given a driver's current viewing angle. An embodiment may thereafter automatically adjust the viewable components, e.g., physically move or reorient the rear and side view mirrors, such that the viewing angles match those known to be optimal for avoiding a collision. This process may be dynamic, e.g., repeated according to an appropriate timing policy such that if the driver moves or shifts, leans one way or another, the viewable components are likewise moved and the appropriate viewing angles are maintained. Once the car is started, the adjustment process may be disabled, e.g., unless the driver requests an update.

Additionally, an embodiment may use stereo camera(s) or a depth camera to obtain three dimensional (3D) spatial data on the user's head position to more precisely determine the current viewing angle(s). Other viewable components, e.g., LCD displays, may also be adjusted, e.g., tilted, to an optimal viewing angle.

For example, in avoiding glare, an embodiment may adjust an LCD display panel such that it is substantially parallel to the user's face and/or eyes. Thus, the LCD panel will not be angled or will have a substantially 0 degree viewing angle (no tilt). This should in most cases minimize glare resulting form a light source as the user's head/body should prevent glare from a light source located directly behind the user. The characteristics of a light source, e.g., its location, intensity, etc., may be utilized in modifying this adjustment. For example, an embodiment may determine a light sources position using the camera or other light sensing method such that the viewing angle for an LCD display is appropriately adjusted.

As may be appreciated the, an embodiment provides a method where detecting, using a sensor, of a current viewing position of a user with respect to a viewable component is used to determine a current viewing angle of the user with respect to the viewable component. Given this information, an embodiment may adjust, e.g., via actuating movement of the viewable component, the orientation of the viewable component based on the current viewing angle determined.

This process may include adjusting an initial position for the viewable components or establishing, via movement of the viewable component, a predetermined viewing angle with respect to the user. This allows, e.g., a driver, to have the initial positions of the viewable components automatically accommodate the particular driver and/or scenario (e.g., light source in the case of an LCD panel). An embodiment may adjust the viewable components such that the appropriate viewing angles are maintained, e.g., via movement of the viewable components in response to a driver repositioning himself or herself. As described herein, different viewable components may be handled differentially, such as in the case of an LCD panel where determining a position of a light source with respect to said display screen may be appropriate.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, from a received sensor input, a current viewing position of a user with respect to a viewable component;
determining, using a processor, a current viewing angle of the user with respect to the viewable component; and
adjusting, via actuating movement of the viewable component, orientation of the viewable component based on the current viewing angle determined.

2. The method of claim 1, wherein said adjusting comprises establishing, via movement of the viewable component, a predetermined viewing angle with respect to the user.

3. The method of claim 1, wherein said adjusting comprises maintaining, via movement of the viewable component, a predetermined viewing angle with respect to the user.

4. The method of claim 1, wherein said detecting comprises:
accepting a captured image of the user from a camera; and
processing said image to determine user head position.

5. The method of claim 4, wherein said detecting further comprises detecting user eye position.

6. The method of claim 1, wherein the detecting further comprises detecting a current viewing position of a user with respect to a viewable component selected from the group consisting of a vehicle mirror and an in-vehicle display screen.

7. The method of claim 6, wherein:
said detecting further comprises detecting a current viewing position of a user with respect to a vehicle mirror; and
said adjusting comprises establishing a predetermined viewing angle.

8. The method of claim 7, wherein said adjusting further comprises dynamically adjusting based on repeated detecting of a current viewing position of a user with respect to the vehicle mirror.

9. The method of claim 6, wherein:
said detecting further comprises detecting a current viewing position of a user with respect to an in-car display screen; and
said adjusting comprises establishing a substantially 0 degree viewing angle.

10. The method of claim 9, further comprising determining a position of a light source with respect to said display screen;
wherein said adjusting further comprises adjusting said substantially 0 degree viewing angle based on a position of said light source.

11. An information handling device, comprising:
a sensor;
a processor operatively coupled to the sensor; and
a memory device storing instructions executable by the processor to:
detect, using the sensor, a current viewing position of a user with respect to a viewable component;
determine a current viewing angle of the user with respect to the viewable component; and
adjust, via actuating movement of the viewable component, orientation of the viewable component based on the current viewing angle determined.

12. The information handling device of claim 11, wherein to adjust comprises establishing, via movement of the viewable component, a predetermined viewing angle with respect to the user.

13. The information handling device of claim 11, wherein to adjust comprises maintaining, via movement of the viewable component, a predetermined viewing angle with respect to the user.

14. The information handling device of claim 11, wherein to detect comprises:
capturing an image of the user using a camera; and
processing said image to determine user head position.

15. The information handling device of claim 14, wherein said user head position further comprises user eye position.

16. The information handling device of claim 11, wherein the viewable component is selected from the group consisting of a vehicle mirror and an in-vehicle display screen.

17. The information handling device of claim 16, wherein:
said viewable component is a vehicle mirror; and
to adjust comprises establishing a predetermined viewing angle.

18. The information handling device of claim 17, wherein to adjust further comprises dynamically adjusting based on repeated detecting of a current viewing position of a user with respect to the vehicle mirror.

19. The information handling device of claim 16, wherein:
said viewable component is an in-car display screen; and
to adjust comprises establishing a substantially 0 degree viewing angle.

20. A vehicle, comprising:
a motor;
one or more wheels operatively coupled to the motor;
a chassis compartment for a user;
a sensor that provides input relating to the chassis compartment;
a processor operatively coupled to the sensor; and
a memory device storing instructions executable by the processor to:
detect, using the sensor, a current viewing position of a user with respect to a viewable component;
determine a current viewing angle of the user with respect to the viewable component; and
adjust, via actuating movement of the viewable component, orientation of the viewable component based on the current viewing angle determined.
